(19) United States
(12) Patent Application Publication
(10) Pub. No.: US 2019/0053038 A1
(43) Pub. Date: Feb. 14, 2019

(54) METHOD FOR HANDLING A SUBSCRIPTION HISTORY

(71) Applicant: GIESECKE+DEVRIENT MOBILE SECURITY GMBH, Munchen (DE)

(72) Inventor: Volker KURTZ, Murnau d. Staffelsee (DE)

(21) Appl. No.: 15/758,783

(22) PCT Filed: Sep. 14, 2016
(86) PCT No.: PCT/EP2016/001542

§ 371 Date: Mar. 9, 2018

(30) Foreign Application Priority Data
Sep. 16, 2015 (DE) 102015012181.2

(51) Int. Cl. H04W 8/18; H04W 8/20

(52) U.S. Cl. CPC H04W 8/183; H04W 8/205

(57) ABSTRACT

A method is provided for handling subscription property data in a secure element of a mobile device. With the method it is possible to establish which subscriptions have ever been deposited on the secure element in the course of the life cycle thereof.

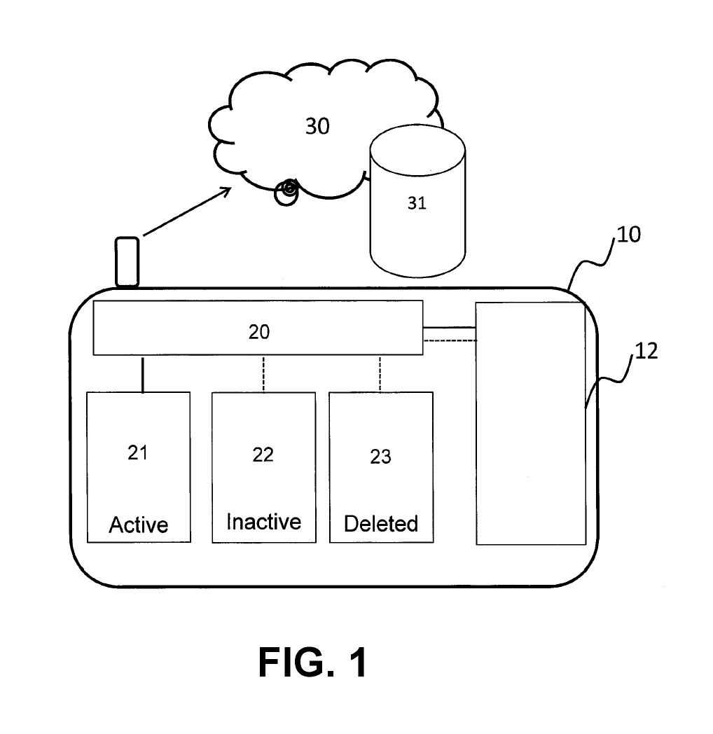

### FIELD OF THE INVENTION

The invention relates to the communication via mobile radio networks in general, and in particular to methods and apparatuses for managing subscription profiles for logging into a mobile radio network, the subscription profiles being deposited on a security element of an end device.

### BACKGROUND OF THE INVENTION

It is known for security elements for end devices in the form of mobile phones, such as a SIM (“Subscriber Identity Module”) or eUICC (“embedded Universal Integrated Circuit Card”) to provide several subscription profiles on such a security element between which one can switch depending on the requirements. Normally, however, there can be active only one subscription profile at a particular time.

In the course of the usage of a mobile device it can be provided that a plurality of subscriptions is loaded into the security element (also referred to as a secure element). This can be necessary in the case a user stays abroad and wants to use a local subscription. Further, the loading of a new subscription is necessary when the user changes his mobile communication provider.

With the change of a subscription it may occur that the previously used subscription leaves “traces”, such as for example harmful data, on the mobile device. Particular subscriptions require, however, that a definite statement can be made about the fact that the mobile device is free of defective data. In the prior art, such a proof is not possible.

### SUMMARY OF THE INVENTION

Against this background, it is the object of the present invention to provide improved methods for handling subscription profiles on a mobile device.

The invention is based on the idea of providing a history of all the subscriptions that have ever been available on a mobile device.

Accordingly, a method for handling a subscription history of a secure element of a mobile device comprises the supplying of a memory device, the providing of the secure element in the mobile device, and the storing of subscription properties in the memory device upon transmission of a subscription to the secure element of the mobile device.

For the purposes of the invention the term “subscription property data” means data which indicate whether a subscription has ever been active, has been transmitted to the mobile device but was always inactive, and/or whether the transmitted subscription was deleted from the secure element.

According to the invention it is especially advantageously possible to recognize which subscriptions have ever been active during the use of the mobile device. In this manner, a subscription to be installed can check whether there has ever been present a subscription on the secure element which could possibly have left harmful data or harmful software on the secure element. An installation of a subscription which could possibly be damaged by a previously installed subscription—no matter whether ever active or always inactive—can therefore advantageously be avoided.

According to an embodiment, a memory location of the subscription property data differs from a memory location of the subscription. This advantageously achieves a secure separation between the actual data of the subscription used or of the subscriptions that have ever been used and the subscription property data.

According to a further particularly preferred embodiment, the memory device is a secure memory device. In this manner it is ensured that the subscription property data are securely stored and cannot be compromised by unauthorized third parties.

According to a further embodiment, the memory device can be arranged on a server, a computer and/or the mobile device, in particular in the secure element of the mobile device. This makes it advantageously possible to store the subscription property data at at least one suitable location from where the subscription property data can be processed in the best possible manner.

According to a further particularly preferred embodiment, in the subscription property data there can be recorded not only whether the transmitted subscription has ever been active, was always inactive and/or whether the transmitted subscription was deleted, but upon deletion of a subscription there can be put an entry in the subscription property data which indicates that the subscription or a part of the subscription was transmitted to the mobile device, in particular to the secure element of the mobile device, at a particular time and is now deleted. The time of deletion can also be recorded in the subscription property data.

According to an alternative, the subscription property data can be stored on the secure element in the memory device before, during and/or after the storing of the subscription. This ensures that the subscription property data are reliably stored in the memory device, so that a subsequent exact subscription history ascertainment is possible. A central processing unit and/or an application (applet) on the secure element can ensure the reliable storing of the subscription property data.

According to a further particularly preferred embodiment, the memory device ascertains at regular intervals which subscriptions are currently available on the secure element and stores the subscription property data of at least one of these subscriptions, preferably of all of these subscriptions, in the memory device. By the regular ascertainment of the available subscriptions there can be added a further security level according to which it is regularly examined whether really all subscriptions are stored in the subscription property data.

The secure element can be a data carrier removably arranged in the mobile device (SIM; Subscriber Identity Module) and/or a data carrier firmly arranged in the mobile device (eUICC; embedded Universal Integrated Circuit Card, or a M2M module). Particularly with the use of the eUICC it is possible to install several different subscriptions at different times thereon. By storing the subscriptions respectively installed on the eUICC in the memory device it becomes possible to reconstruct which subscriptions have ever been available in the eUICC.

The advantages according to the invention further can be found in a mobile device having a secure element and a memory device, the mobile device being arranged to carry out a method with the above-mentioned aspects.

Furthermore, the advantages according to the invention can be found in a system comprising a secure element as well as a memory device, the system being configured to carry out a method according to any of the above-mentioned aspects.

### BRIEF DESCRIPTION OF THE DRAWING

The FIGURE schematically shows a secure element on which a plurality of subscriptions is available, as well as a network memory.

### DETAILED DESCRIPTION OF PREFERRED EMBODIMENTS OF THE INVENTION

In the following, preferred embodiments of the invention are described with reference to the FIGURE.

The FIGURE shows a secure element 10 which can be built in, for example, in the form of a firmly built-in secure element (eUICC) in a mobile device, such as for example a mobile phone, a tablet PC, an eBook reader, and the like. The secure element 10 is used for the identification of the user against the mobile network operator (MNO). Secure elements are known in the prior art, so that a detailed description is omitted herein.

The secure element 10 is provided with a computing unit 20 as well as a memory. In the memory, subscriptions 21, 22, 23 can be stored. A subscription has deposited therein to which network of a mobile network operator the mobile device has to log in. Furthermore, there can be set further details, such as for example the numbers which the user may dial, as well as the maximum data transmission speeds which are available to the user, etc.

Furthermore, the secure element is provided with an additional memory device 12. In this memory device 12 subscription property data are stored. These subscription property data have information about all the subscriptions 21, 22, 23 which ever have been available on the secure element. The subscription property data may have deposited therein, for example, whether a subscription 21 has ever been active, has always been inactive 22, or whether the subscription 23 was deleted. This can ensure that when a new subscription 21, 22, 23 is transmitted to the secure element 10 no harmful subscriptions that are classified as security-critical were previously available on the secure element. The additional memory device can be, according to an embodiment, a part of the memory device 20 of the secure element 10.

In addition or alternatively, the subscription property data can be transmitted via a network 30 to a remote memory device 31. The remote memory device 31 can be a network memory or a cloud memory device. The transmission of the data to the remote memory device 31 has the advantage that the subscription property data can be retrieved from this memory at any time.

In the subscription property data there can further be stored in which order the subscriptions 21, 22, 23 were stored on the secure element 12. The order of the stored subscriptions 21, 22.23 can additionally be provided with a time stamp.

Furthermore, the subscription property data can be evaluated by means of an application.

1.-11. (canceled)

12. A method for handling a subscription history of a secure element of a mobile device, having the following steps:
suppling a memory device,
providing the secure element in the mobile device, and
storing subscription property data in the memory device upon transmission of a subscription to the secure element of the mobile device.

13. The method according to claim 12, wherein a memory location of the subscription property data differs from a memory location of the subscription.

14. The method according to claim 12, wherein the memory device is a secure memory device.

15. The method according to claim 12, wherein the memory device is arranged on a server, a computer, and/or the mobile device, in particular in the secure element.

16. The method according to claim 12, wherein in the subscription property data it is recorded whether the transmitted subscription has ever been active, has always been inactive, and/or whether the transmitted subscription was deleted.

17. The method according to claim 12, wherein upon deletion of a subscription an entry is put in the subscription property data.

18. The method according to claim 12, wherein the subscription property data are stored on the secure element before, during, and/or after the storing of the subscription.

19. The method according to claim 12, wherein at regular intervals the memory device ascertains which subscriptions are available on the secure element and stores the subscription property data of at least one of these subscriptions in the memory device.

20. The method according to claim 12, wherein the secure element is a data carrier removably arranged in the mobile device and/or a data carrier firmly arranged in the mobile device.

21. A mobile device having a secure element and a memory device, wherein the mobile device is configured to carry out a method according to claim 12.

22. A system comprising a secure element as well as a memory device, wherein the system is configured to carry out a method according to claim 12.
